(19) United States
(12) Patent Application Publication
(10) Pub. No.: US 2014/0352186 A1
(43) Pub. Date: Dec. 4, 2014

(54) DATE MARKING TAG

(71) Applicant: FENG-CHENG LIN, Taichung City (TW)

(72) Inventor: FENG-CHENG LIN, Taichung City (TW)

(21) Appl. No.: 13/906,070

(22) Filed: May 30, 2013

(51) Int. Cl. G09D 3/00; G09F 3/10

(52) U.S. Cl. CPC G09D 3/00; G09F 3/10
USPC 40/638

(57) ABSTRACT

A date marking tag has a circular substrate, the substrate having three marking areas respectively for year, month and day and having an adhesive agent on a back side of the substrate. The date marking tag can also have a laminate layer, the substrate made of a transparent film, and the laminate layer being a toner film with a dark colored side, the laminate layer corresponding to the back side. The three different marking areas are respectively colored in three different colors. The date marking tag can have a rectangular substrate, the substrate having a one week calendar marking area in both Chinese and English and an adhesive agent on a back side. The substrate can have a one week calendar marking area respectively for twelve months and 31 calendar days and an adhesive agent on a back side.

### BACKGROUND OF THE INVENTION

1. Field of the Invention

The present invention relates to a date marking tag, and more particularly to date marking tag for marking an opening date of a container.

2. Description of the Related Art

Medications, nutrition supplements, formula milk, food . . . etc are packed in sealed packages or container for storage reason. Manufacturers need to mark manufacturing date and expiration date on the packages. For medications, nutrition supplements, formula milk . . . such materials containing low moisture, after the seal is broken, the safe storage time period is usually one month. However, for food such material containing higher moisture and nutrition, after the seal is broken, the safe storage time period is usually a few days or a week maximum. Without recording the seal broken date might cause health issue and wasting issue. Furthermore, even trying to wire the date on the container is difficult, because most of time the writing will not stay on the container.

Therefore, it is desirable to provide a date marking tag to mitigate and/or obviate the aforementioned problems.

### SUMMARY OF THE INVENTION

An objective of the present invention is to provide a date marking tag for marking an opening date of a container.

In order to achieve the above mentioned objective, A date marking tag comprising a circular substrate, the substrate having three marking areas respectively for year, month and day and having an adhesive agent on a back side of the substrate. The date marking tag further comprises a laminate layer, the substrate is made of a transparent film, and the laminate layer is a toner film with a dark colored side, and the laminate layer corresponds to the back side. The three different marking areas of the date marking tag are respectively colored in three different colors. the date marking tag has a rectangular substrate, the substrate having a one week calendar marking area in both Chinese and English and an adhesive agent on a back side. the substrate having a one week calendar marking area respectively for twelve months and 31 days calendar and an adhesive agent on a back side. Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a date marking tag according to a first embodiment of the present invention.

FIG. 2 is a schematic drawing showing date marking tag shown in FIG. 1 being marked with a date according to the first embodiment of the present invention.

FIG. 3 shows the date marking tag and a laminate layer according to the first embodiment of the present invention.

FIG. 4 shows the date marking tag having one week calendar according to another embodiment of the present invention.

FIG. 5 shows the date marking tag shown in FIG. 4 being marked with a date.

FIG. 6 shows the date marking tag having a calendar showing twelve months and 31 days according to another embodiment of the present invention.

FIG. 7 shows the date marking tag shown in FIG. 6 being marked with a date.

### DETAILED DESCRIPTION OF THE PREFERRED EMBODIMENT

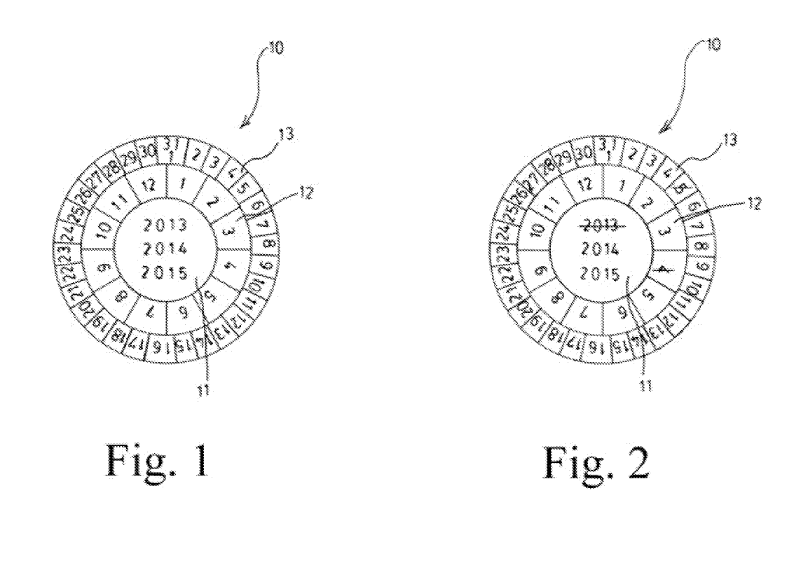

Please refer to FIG. 1 and FIG. 2. FIG. 1 is a schematic drawing of a date marking tag according to a first embodiment of the present invention. FIG. 2 is a schematic drawing showing date marking tag shown in FIG. 1 being marked with a date according to the first embodiment of the present invention. A date marking tag 10 comprises a circular substrate, and the substrate has three marking areas 11, 12 and 13. The first marking area 11 is provided with three different year sections, the second marking area 12 is provided with twelve different months sections, and the third marking area 13 is provided with thirty-one dates sections. The date marking tag 10 has an adhesive agent on a back side of the substrate. As shown in FIG. 2, a user can mark the year sections indicating 2013 in the first marking area 11, the month section indicating 4 in the second marking area 12 and the dates sections indicating 5 in the third marking area 13, to date as Apr. 5, 2013.

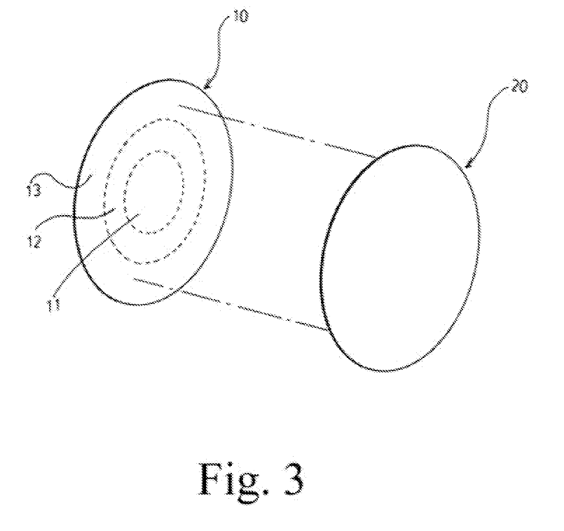

Please refer to FIG. 3. Alternatively, the date marking tag 10 is made of a transparent film or the first, second and third marking areas 11, 12, 13 are respectively provided with different color(light colors) and a laminate layer 20 is overlapped onto to the back side of the date marking tag 10. The laminate layer 20 is a toner film with a dark colored side, and the laminate layer 20 corresponds to the back side of the date marking tag 10. Accordingly, the user just needs to scratch the first, second and third marking areas 11, 12, 13 with a sharp object, to mark the date.

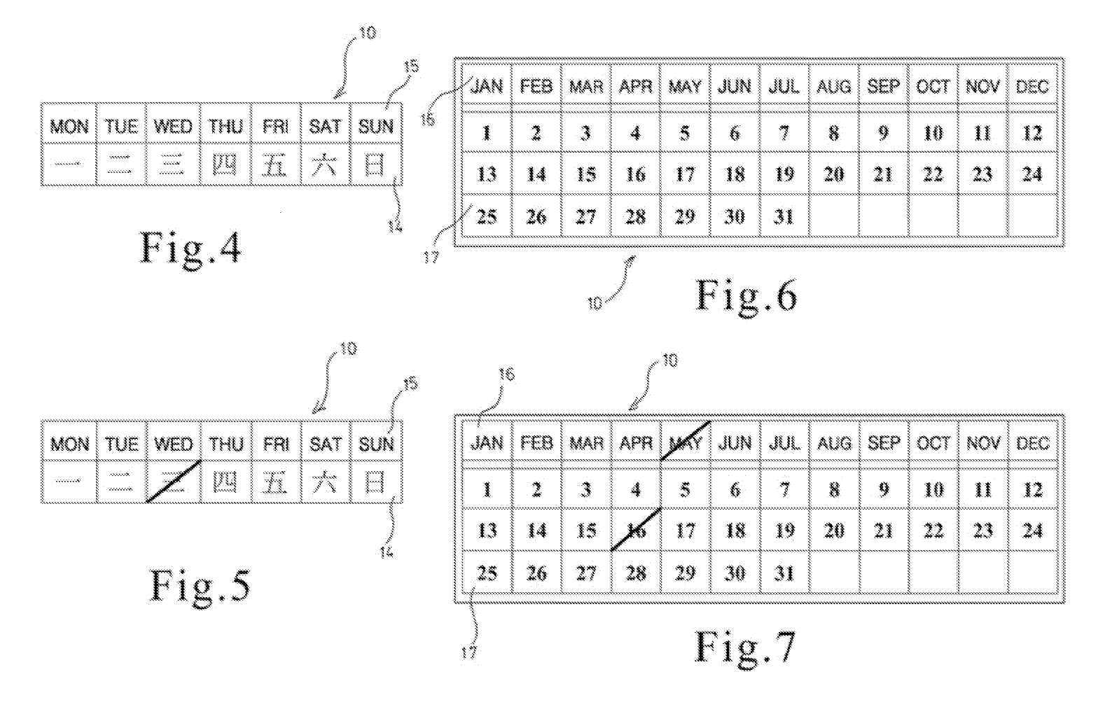

As shown in FIG. 4 and FIG. 5, the date marking tag 10 is a rectangular shape, which is provided with both Chinese and English calendars areas 14, 15. When

As shown in FIG. 6 and FIG. 7, the date marking tag 10 is a rectangular shape, which is provided with a twelve months calendar area 16 and a thirty-one days calendar area 17.

Although the present invention has been explained in relation to its preferred embodiment, it is to be understood that many other possible modifications and variations can be made without departing from the spirit and scope of the invention as hereinafter claimed.

What is claimed is:

1. A date marking tag comprising a circular substrate, the substrate having three marking areas respectively for year, month and day and having an adhesive agent on a back side of the substrate.

2. The date marking tag as claimed in claim 1, wherein the date marking tag further comprises a laminate layer, the substrate is made of a transparent film, and the laminate layer is a toner film with a dark colored side, and the laminate layer corresponds to the back side.

3. The date marking tag as claimed in claim 1, wherein the three different marking areas of the date marking tag are respectively colored in three different colors.

4. A date marking tag comprising a rectangular substrate, the substrate having a one week calendar marking area in both Chinese and English and an adhesive agent on a back side.

5. A date marking tag comprising a rectangular substrate, the substrate having a calendar marking area subdivided into a twelve month calendar and a 31 day calendar, an adhesive agent disposed on a back side of the substrate.
